(19) United States
(12) Patent Application Publication
(10) Pub. No.: US 2009/0300588 A1
(43) Pub. Date: Dec. 3, 2009

(54) METHOD AND APPARATUS FOR ACQUIRING DEFINITIONS OF DEBUG CODE OF BASIC INPUT/OUTPUT SYSTEM

(75) Inventor: ZHENG-QUAN PENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/178,655

(22) Filed: Jul. 24, 2008

(30) Foreign Application Priority Data
May 30, 2008 (CN) 200810301873.0

(51) Int. Cl. G06F 9/44

(52) U.S. Cl. 717/131

(57) ABSTRACT

An apparatus for acquiring information on debug codes of BIOS includes an information memory module, a detecting module, a control module, and an information display module. The information memory module is capable of storing POST codes and information corresponding to the POST codes. The detecting module is capable of real-time scanning address port of a bus of, for example, a motherboard, and transforming data from the address port to POST codes. The control module is capable of receiving the detected POST codes from the detecting module, and comparing the detected POST codes with the stored POST codes in the information memory module to look up information corresponding to the detected POST codes. An information display module is controlled by the control module and capable of displaying the detected POST codes and the information corresponding to the detected POST codes.

### BACKGROUND

1. Field of the Invention

The invention relates to a method and an apparatus for looking up debug codes of a Basic Input/Output System (BIOS), more particularly to a method and an apparatus capable of acquiring and displaying the debug code information for a BIOS.

2. Description of Related Art

Most contemporary electronic system, such as motherboards, interface cards, etc., are provided with BIOS for power-on self tests (POST) and access of default set-up data upon initialization.

Due to the trend of computers toward multitasking operations, the operations associated with BIOS have grown in complexity. In the development stages of a computer system, even before an operating system is loaded, different factors, such as failure of some components, errors in BIOS codes, etc., may result in boot-up failure and hinder development progress.

Conventionally, a method and an apparatus for looking up debug codes of a BIOS only can display the POST codes on the screen of the apparatus. User must then look up definitions of the POST codes, which is inconvenient and time consuming.

What is needed is a method and an apparatus for precisely and conveniently acquiring and displaying the information about the POST codes of a BIOS.

### BRIEF DESCRIPTION OF THE DRAWINGS

FIG. 1 is a block diagram of an apparatus for acquiring information on debug codes of a BIOS in accordance with an exemplary embodiment of the present invention; and

FIG. 2 is a flowchart of a method for acquiring information on debug codes of a BIOS in accordance with another exemplary embodiment of the present invention.

### DETAILED DESCRIPTION

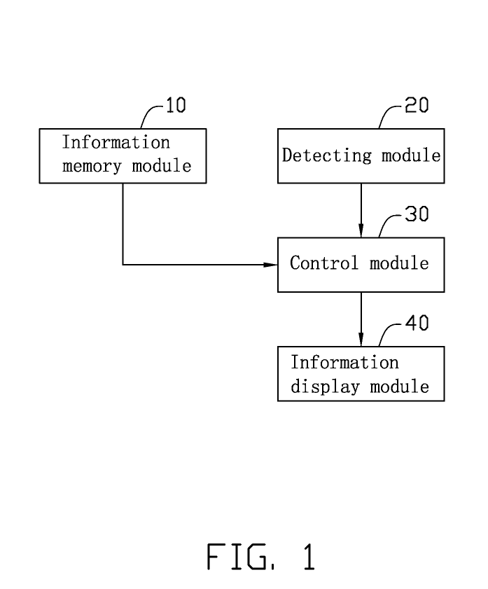

Referring to FIG. 1, an apparatus for acquiring information on debug codes of a BIOS in accordance with an exemplary embodiment of the present invention includes an information memory module 10, a detecting module 20, a control module 30, and an information display module 40. In this embodiment, the control module 30 is a microprocessor.

The information memory module 10 is used for storing debug codes or POST codes and information corresponding to the POST codes of different BIOS manufacturers, such as PHOENIX, AMI, and AWARD, etc. The detecting module 20 is used for real-time scanning of address port of a bus of, for example, a motherboard, such as port 80 of ISA bus, and transforming data from the address port to POST codes. The control module 30 is used for receiving the detected POST codes from the detecting module 20, and comparing the detected POST codes with stored POST codes in the information memory module 10 to look up information corresponding to the detected POST codes. The control module 30 controls the detected POST codes and the information corresponding to the detected POST codes to be displayed by the information display module 40. In this embodiment, the information display module 40 is an LED-display screen or other display device.

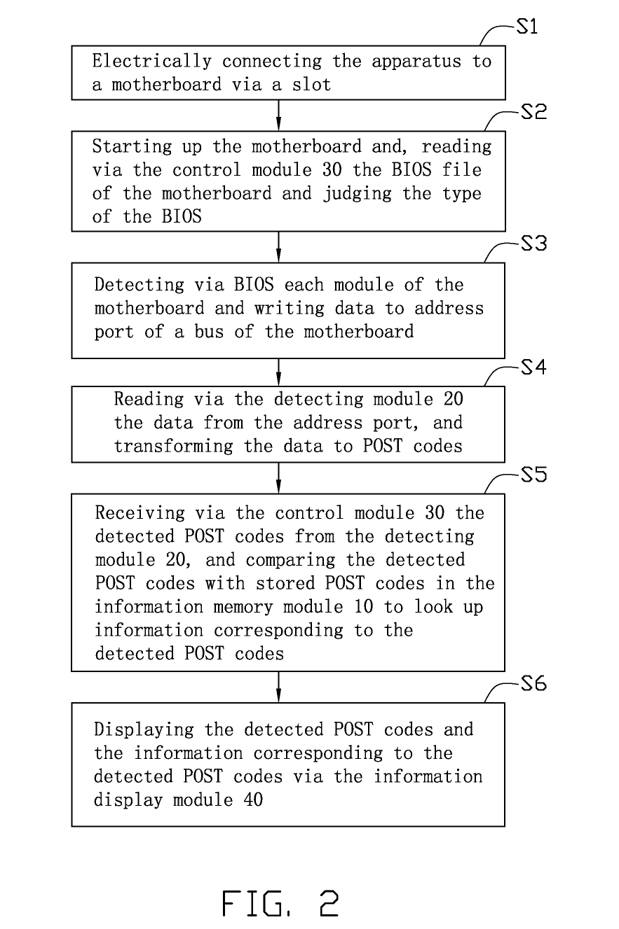

Referring to FIG. 2, a method of acquiring information on debug codes of a BIOS of a motherboard in accordance with another exemplary embodiment of the present invention includes the following steps.

Step S1: electrically connecting the apparatus to a motherboard via a slot. The slot may be a PCI slot or an ISA slot.

Step S2: starting up the motherboard and, reading via the control module 30 the BIOS file of the motherboard and judging the type of the BIOS.

Step S3: detecting via BIOS each module of the motherboard and writing data to address port of a bus of the motherboard.

Step S4: reading via the detecting module 20 the data from the address port, and transforming the data to the POST codes.

Step S5: receiving via the control module 30 the detected POST codes from the detecting module 20, and comparing the detected POST codes with stored POST codes in the information memory module 10 to look up information corresponding to the detected POST codes.

Step S6: displaying the detected POST codes and the information corresponding to the detected POST code via the information display module 40.

Giving an example to further illustrate the method, if the detected POST code is “00”, the information corresponding to the detected POST code is “the motherboard not normal POST”. The information display module 40 will display the detected POST code “00” and the information “the motherboard not normal POST” to user.

The apparatus and method of acquiring information on debug codes of a BIOS may look up the information corresponding to the detected POST code conveniently for user.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An apparatus of acquiring information on debug codes of BIOS, comprising:
an information memory module capable of storing POST codes and information corresponding to the POST codes;
a detecting module capable of real-time scanning address port of a bus of, for example, a motherboard, and transforming data in the address port to POST codes;
a control module capable of receiving the detected POST codes from the detecting module, and comparing the detected POST codes with stored POST codes in the information memory module to look up information corresponding to the detected POST codes;
an information display module controlled by the control module and capable of displaying the detected POST codes and the information corresponding to the detected POST codes.

2. The apparatus as claimed in claim 1, wherein the address port is port 80 of an ISA bus.

3. The apparatus as claimed in claim 1, wherein the apparatus is electrically connected to the motherboard via a connecting slot of a PCI slot or an ISA slot of the motherboard.

4. The apparatus as claimed in claim 1, wherein the control module is a microprocessor.

5. The apparatus as claimed in claim 1, wherein the information display module is an LED-display screen.

6. A method of acquiring information on debug codes of a BIOS using the apparatus of claim 1, the method comprising:
electrically connecting the apparatus to a motherboard via a slot;
starting up the motherboard and reading via the control module the BIOS file of the motherboard and judging the type of the BIOS;
detecting via BIOS each module of the motherboard and writing data to the address port of a bus of the motherboard;
reading via the detecting module the data from the address port and transforming the data to POST codes;
receiving via the control module the detected POST codes from the detecting module, and comparing the detected POST codes with the stored POST codes in the information memory module to look up information corresponding to the detected POST codes; and
displaying the detected POST codes and the information corresponding to the detected POST codes via the information display module.

7. The method as claimed in claim 6, wherein the address port is port 80 of an ISA bus.

8. The method as claimed in claim 6, wherein the apparatus is electrically connected to the motherboard via a connecting slot of a PCI slot or an ISA slot of the motherboard.

9. The method as claimed in claim 6, wherein the control module is a microprocessor.

10. The method as claimed in claim 6, wherein the information display module is an LED-display screen.
